(19) United States
(12) Patent Application Publication
(10) Pub. No.: US 2018/0327230 A1
(43) Pub. Date: Nov. 15, 2018

(54) ELEVATOR

(71) Applicant: Kone Corporation, Helsinki (FI)

(72) Inventors: Matti RASANEN, Helsinki (FI); Markku HAAPANIEMI, Helsinki (FI); Jorma MUSTALAHTI, Hyvinkaa (FI); Esko AULANKO, Helsinki (FI); Janne MIKKONEN, Helsinki (FI)

(73) Assignee: Kone Corporation, Helsinki (FI)

(21) Appl. No.: 16/043,530

(22) Filed: Jul. 24, 2018

Related U.S. Application Data
(63) Continuation of application No. PCT/FI2016/050033, filed on Jan. 25, 2016.

(51) Int. Cl. B66B 11/04; B66B 9/00; B66B 11/00; H02K 5/22; H02K 7/10; H02K 9/06; H02K 11/33; H02K 11/21

(52) U.S. Cl. CPC B66B 11/043; B66B 9/00; B66B 11/0045; H02K 11/21; H02K 7/1004; H02K 9/06; H02K 11/33; H02K 5/225

(57) ABSTRACT

The elevator comprises a car moving upwards and downwards in an elevator shaft by a lifting machinery comprising a drive unit, an electric motor having an axis of rotation forming an axial direction (X-X), and a drive pulley, the drive unit being connected to an electrical power source and providing a controllable source of power to the electric motor, and transmission means passing over the drive pulley and being connected to the car. The drive unit comprises a first end surface and the electric motor comprises a first end surface, the drive unit being attached to the electric motor so that a predetermined axial distance (X1) remains between the first end surface of the drive unit and the first end surface of the electric motor, said first end surfaces being opposite to each other.

This application is a continuation of PCT International Application No. PCT/FI2016/050033 which has an International filing date of Jan. 25, 2016, the entire contents of which are incorporated herein by reference.

### FIELD OF THE INVENTION

The invention relates to an elevator.

### BACKGROUND ART

An elevator comprises typically a car, an elevator shaft, lifting machinery, support means, and a counter weight or balancing weight. The term counter weight will be used in the rest of the text meaning either a counter weight or a balancing weight. The elevator car is positioned within a sling that supports the car. The lifting machinery may comprise a drive pulley, a machinery brake and an electric motor for rotating the drive pulley. The lifting machinery moves the car in a vertical direction upwards and downwards in the vertically extending elevator shaft. The support means i.e. the ropes and/or belts connect the sling and thereby also the car via the drive pulley to the counter weight. The sling may further be supported with gliding means on guide rails extending in the vertical direction in the shaft. The gliding means may comprise rolls rolling on the guide rails or gliding shoes gliding on the guide rails when the elevator car is mowing upwards and downwards in the elevator shaft. The guide rails may be supported with fastening brackets on the side wall structures of the elevator shaft. The gliding means engaging with the guide rails keep the car in position in the horizontal plane when the car moves upwards and downwards in the elevator shaft. The counter weight may be supported in a corresponding way on guide rails supported on the wall structure of the shaft. The elevator car transports people and/or goods between the landings in the building. The elevator shaft can be formed so that the wall structure is formed of solid walls or so that the wall structure is formed of an open steel structure.

The lifting machinery may be positioned at the top of the shaft or at the bottom of the shaft or in the shaft between the top and the bottom of the shaft. An elevator having the lifting machinery positioned at the top of the shaft may be called a top driven elevator. The support means may pass from the top of the car over the drive pulley and down to the top of the counter weight. An elevator having the lifting machinery positioned at the bottom of the shaft may be called a bottom driven elevator. A bottom driven elevator may comprise an upper suspension rope and a lower traction belt. The upper suspension rope passes from a top of the car over upper deflection pulleys positioned in the upper portion of the shaft to a top of the counter weight. The lower traction belt passes from a bottom of the car over the drive pulley and lower deflection pulleys positioned in the lower portion of the shaft to a bottom of the counter weight. The suspension rope may be a round steel rope. There may be one or several separate parallel connected suspension ropes running over the drive pulley. The traction belt may be a flat belt provided with cogs being received by corresponding cogs in the drive pulley. There may be one or several separate parallel connected traction belts running over the drive pulley.

U.S. Pat. No. 8,922,074 discloses an elevator machine motor and drive and cooling thereof. Heat in a drive system including a motor and a drive is removed using heat conducting elements in heat exchanging contact with the motor and the drive. The heat conducting element have at least a portion for receiving heat from the motor or the drive, and another portion to transfer heat to a heat exchange device that is spaced from the motor and the drive. The heat conducting element may be a heat pipe or a heat spreader element. The drive and the motor may be separated from each other in space, whereby each of the drive and the motor have at least one heat conducting element in heat exchanging contact therewith. The other possibility is that the drive and the motor are integrated to provide a unitary device for contact with at least one heat conducting element.

WO publication 2005/040024 discloses an elevator and its control. The elevator comprises a car and a drive apparatus for moving the elevator car. The drive apparatus comprises an AC elevator motor and a frequency converter, which comprises a rectifier, an inverter and a DC circuit between them. The rectifier and the inverter are separate and the inverter is integrated with the motor.

### BRIEF DESCRIPTION OF THE INVENTION

An object of the present invention is to achieve an improved pulley driven elevator.

The elevator is defined in claim 1.

The elevator comprises a car moving upwards and downwards in an elevator shaft by a lifting machinery comprising a drive unit, an electric motor having an axis of rotation forming an axial direction, and a drive pulley, the drive unit being connected to an electrical power source and providing a controllable source of power to the electric motor, transmission means passing over the drive pulley and being connected to the car. The drive unit comprises a first end surface and the electric motor comprises a first end surface, the drive unit being attached to the electric motor so that a predetermined axial distance remains between the first end surface of the drive unit and the first end surface of the electric motor, said first end surfaces being opposite to each other.

The space between the first end surface of the drive unit and the first end surface of the electric motor forms a radially directed cooling air channel between said first end surfaces. Said cooling air channel is needed in order to be able to cool the drive unit and the electric motor effectively. The cooling air channel eliminates also effectively heat transfer from the drive unit to the motor and from the motor to the drive unit.

The lifting machinery can be positioned anywhere in the shaft, e.g. at the top of the shaft or at the bottom of the shaft or somewhere between the top and the bottom of the shaft. The drive unit and the electric motor can be cooled with the free flow of the surrounding air or by means of a fan.

The fan can be positioned on the shaft of the electric motor in the space between the first end surfaces or within the electric motor at either axial end of the electric motor, whereby the fan rotates with the rotor of the electric motor.

The fan can on the other hand be positioned in an external position in relation to the lifting machinery, whereby the fan directs cooling air to the drive unit and the electric motor and thereby also to the space between the first end surfaces of the drive unit and the electric motor. A cooling air channel arrangement can be used in order to conduct air from the fan to the drive unit and the electric motor.

The drive unit may comprise a first casing, whereby the first end surface of the drive unit may be formed of a first end surface of the first casing. A sensor measuring the rotation speed or the angular position of the rotor of the electric motor may be integrated into the casing of the drive unit in this arrangement.

The lifting machinery can be assembled into a complete lifting machinery unit already at the factory. This makes it easy to test the complete lifting machinery unit already at the factory.

The installation time required at the installation site can be reduced due to the fact that the complete lifting machinery unit may be lifted in one lift operation to the correct position on the installation site.

It is possible to achieve savings in material costs due to the integrated construction.

The quality can be improved due to the reduced number of components and due to the fact that the complete lifting machinery unit may be tested in factory conditions already at the manufacture of the unit in the factory.

The use of space may be more effective due to the integration of the drive unit and the electric motor.

Distance means in the form of first protrusions attached to the first end surface of the drive unit or to the first end surface of the electric motor distributed along the perimeter of the respective first end surface and extending axially outwards towards the opposite first end surface may be provided, whereby the axial distance between the opposite first end surfaces may be determined by the first protrusions.

Second protrusions may be used to form the connection between the drive unit and the electric motor, whereby the second protrusions may be adapted to engage into contact with corresponding fastening means in the respective opposite first end surface. The drive unit and the electric motor become attached to each other through the second protrusions and the fastening means so that an axial distance between the respective opposite first end surfaces is formed and determined by the axial length of the second protrusions.

The second protrusions and the fastening means may be formed so that a snap locking is achieved between the drive unit and the electric motor.

The first end surface of the drive unit may comprise electrical socket connections and the first end surface of the electric motor may comprise corresponding electrical plug connections or vice a versa. The electrical plug connections will be pushed automatically into the electrical socket connections when the drive unit is attached to the electric motor. All external wiring between the drive unit and the electric motor can thus be eliminated. The only external wiring needed is thus the electrical power supply wiring to the drive unit and the data transfer wiring between the drive unit and the main control unit of the elevator.

The drive unit can easily be detached from the electric motor making it easy to replace the drive unit with a new one in case the drive unit brakes down.

The drive unit and the electric motor may be cooled by air. The air cooling may be intensified with an arrangement using a cooling liquid in order to transfer heat from the drive unit and/or the electric motor to the cooling liquid.

### BRIEF DESCRIPTION OF THE DRAWINGS

The invention will in the following be described in greater detail by means of preferred embodiments with reference to the attached drawings, in which

FIG. 1 shows a first vertical cross section of an elevator,

FIG. 2 shows a second vertical cross section of an elevator,

FIG. 3 shows a lifting machinery of an elevator,

FIG. 4 shows the lifting machinery of FIG. 3 with the drive unit disconnected,

FIG. 5 shows a vertical and a horizontal cross section of a lifting machinery enclosed in a watertight box.

### DETAILED DESCRIPTION OF EMBODIMENTS OF THE INVENTION

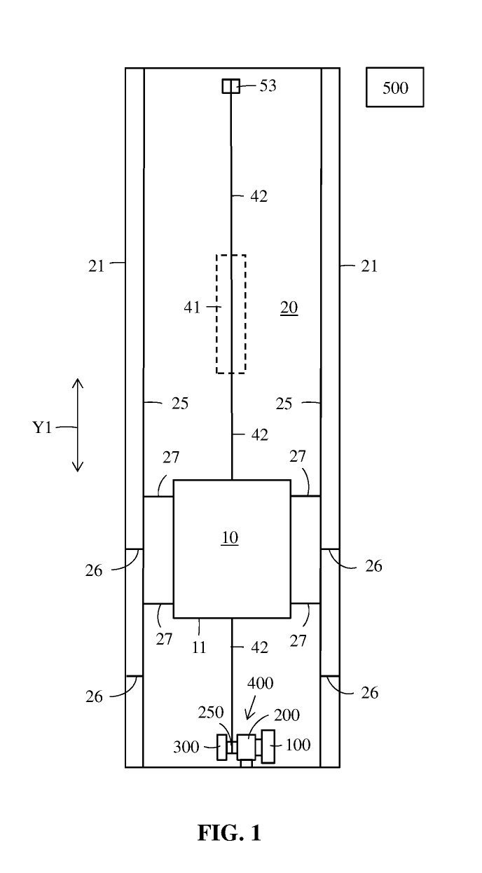

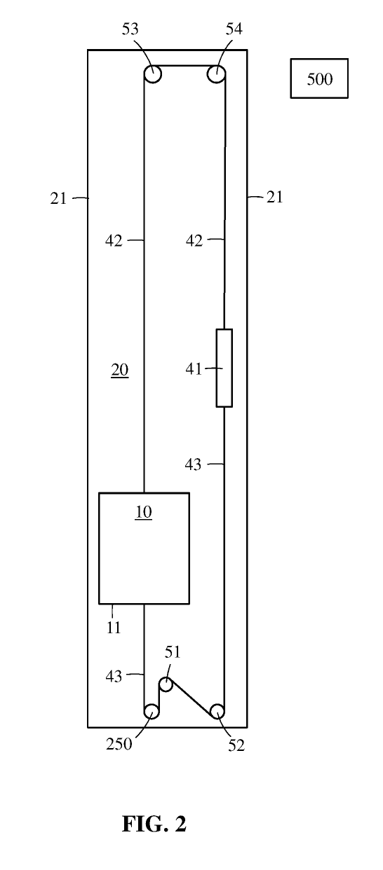

FIG. 1 shows a first vertical cross section and FIG. 2 a second vertical cross section of an elevator. The elevator comprises a car 10, an elevator shaft 20, lifting machinery 400, a counter weight or balancing weight 41, and transmission means 42, 43. The term counter weight will be used in the rest of the text meaning either a counter weight or a balancing weight. A sling 11 may surround the car 10. The sling 11 may be a separate sling 11 surrounding the car 10 or the sling 11 may be formed as an integral part of the frame of the car 10. The lifting machinery 400 comprises a drive 100, an electric motor 200, a drive pulley 250, and a machinery brake 300.

The transmission means 42, 43 may comprise an upper suspension rope 42 and a lower traction belt 43. The upper suspension rope 42 may be formed of a single suspension rope 42 or of several separate parallel connected suspension ropes 42. The lower traction belt 43 may be formed of a single traction belt 43 or of several separate parallel connected traction belts 43. The upper suspension rope 42 passes from a top of the car 10 over upper deflection pulleys 53, 54 positioned in the upper portion of the shaft 20 to a top of the counter weight 41. The lower traction belt 43 passes from a bottom of the car 10 over the drive pulley 250 and over lower deflection pulleys 51, 52 to a bottom of the counter weight 41. The drive pulley 250 and the lower deflection pulleys 51, 52 are all positioned in the lower portion of the shaft 20. The lower traction belt 43 may comprise a cogging on the inner surface of the lower traction belt 43 i.e. the surface that is in contact with the drive pulley 250 and the lower deflection pulley 52. The drive pulley 250 and the lower deflection pulley 52 may comprise a corresponding cogging fitting into the cogging of the lower traction belt 43. The car 10 and the counter weight 41 are connected with the suspension rope 42 and the traction belt 43 so that a closed loop is formed. The lower deflection pulley 51 is positioned above the drive pulley 250 and ensures that the wrap angle of the traction belt 43 around the drive pulley 250 is big enough. The wrap angle of the traction belt 43 around the drive pulley 250 may advantageously be in the order of 90 to 180 degrees.

The lifting machinery 400 may be attached on pivot arms, whereby turning of the lifting machinery 400 around the pivot points moves the drive pulley 250 and thereby affects the tension of the suspension rope 42 and the traction belt 43.

The drive pulley 250 is connected directly to the shaft of the electric motor 200, whereby the drive pulley 250 rotates in synchronism with the rotation of the rotor of the electric motor 200. The car 10 and the counter weight 41 are moved in synchronism in opposite directions in the vertically Y1 extending elevator shaft 20. Rotation of the drive pulley 250 clockwise results in that the car 10 moves upwards and the counter weight 41 moves downwards. Rotation of the drive pulley 250 counter clockwise results in that the car 10 moves downwards and the counter weight 41 moves upwards.

The sling 11 and thereby also the car 10 may be supported with gliding means 27 at guide rails 25 extending in the vertical direction in the shaft 20. The figure shows two guide rails 25 at opposite sides of the car 10. The gliding means 27 can comprise rolls rolling on the guide rails 25 or gliding shoes gliding on the guide rails 25 when the car 10 is mowing upwards and downwards in the elevator shaft 20. The guide rails 25 are attached with fastening brackets 26 to the side wall structures 21 in the elevator shaft 20. The figure shows only two fastening brackets 26, but there are several fastening brackets 26 along the height of each guide rail 25. The gliding means 27 engaging with the guide rails 25 keep the car 10 in position in the horizontal plane when the car 10 moves upwards and downwards in the elevator shaft 20. The counter weight 41 is supported in a corresponding way on guide rails that are attached to the wall structure 21 of the shaft 20. The machinery brake 300 stops the rotation of the drive pulley 250 and thereby the movement of the elevator car 10. The car 10 transports people and/or goods between the landings in the building. The elevator shaft 20 can be formed so that the wall structure 21 is formed of solid walls or so that the wall structure 21 is formed of an open steel structure.

The lifting machinery 400, the car doors and the landing doors are controlled by a main control unit 500.

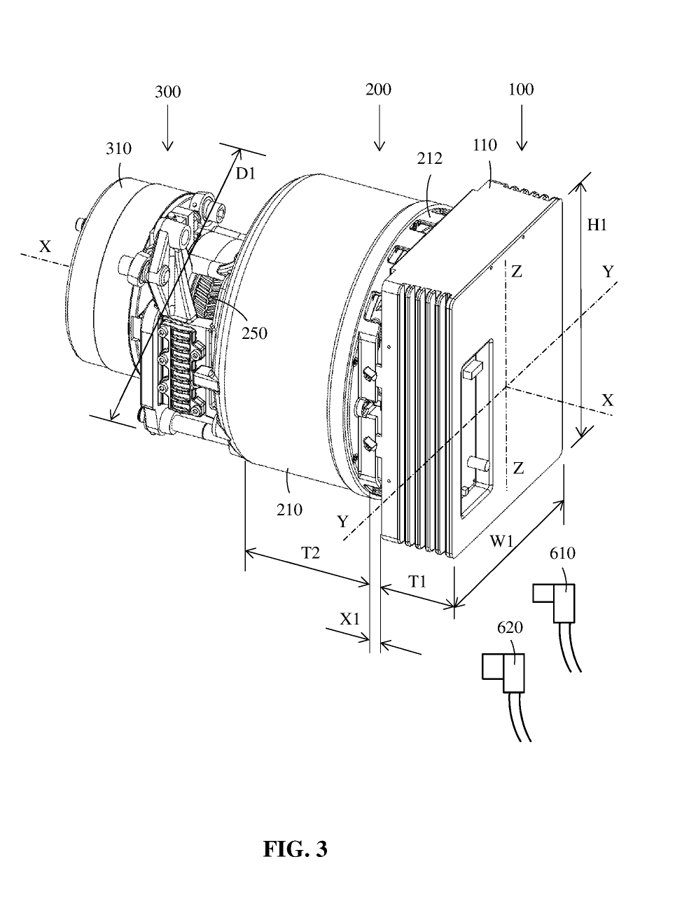

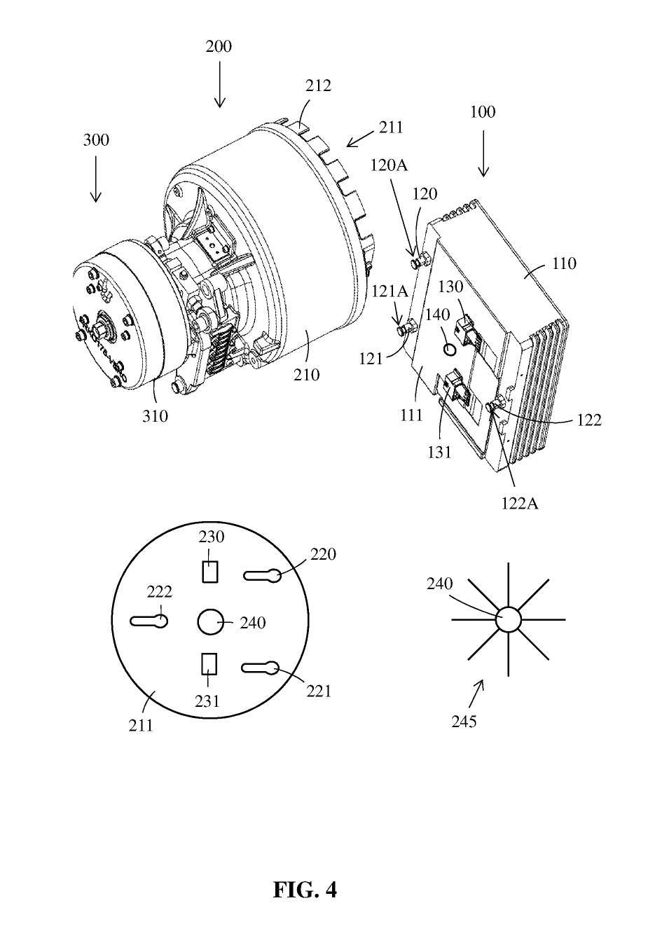

FIG. 3 shows a lifting machinery of an elevator and FIG. 4 shows the lifting machinery of FIG. 3 with the drive unit disconnected. The lifting machinery 400 is formed of a drive unit 100, an electric motor 200, a drive pulley 250 and a machinery brake 300. The axis of rotation of the electric motor 200 forms an axial direction X-X. The a drive unit 100, the electric motor 200, the drive pulley 250 and the machinery brake 300 of the lifting machinery 400 may advantageously be positioned one after the other along the axial direction X-X. The axis of rotation of the electric motor 200, the drive pulley 250 and the machinery brake 300 coincide advantageously with each other. A centre axis of the drive unit 100 coincides also advantageously with the axes of rotation of the electric motor 200, the drive pulley 250 and the machinery brake 300. The drive unit 100 may comprise a first casing 110 having a generally rectangular shape. All the components of the drive unit 100 may be enclosed within the first casing 110. The electric motor 200 may comprise a second casing 210 having a generally cylindrical shape. All the components of the electric motor 200 e.g. the stator, the rotor and all the other equipment of the electric motor 200 may be enclosed within the second casing 210. The second casing 210 may be formed by the frame construction of the electric motor 200. The machinery brake 300 may comprise a third casing 310 having a generally cylindrical shape. All the components of the machinery brake 300 may be enclosed within the third casing 310. The lifting machinery 400 may form a unit where all the components i.e. the drive unit 100, the electric motor 200, the drive pulley 250 and the machinery brake 300 are attached to each other. The drive unit 100 is thus supported by the electric motor 200 when the drive unit 100 is attached to the electric motor 200. The lifting machinery 400 may be supported e.g. from support points arranged on the frame of the drive pulley 250 to a frame construction, which is not shown in the figure. The support may be a stationary support or a pivot support.

A first end surface 111 of the drive unit 100 i.e. a first end surface 111 of the first casing 110 and a first end surface 211 of the electric motor 200 i.e. a first end surface 211 of the second casing 210 are at a predetermined axial X-X distance X1 from each other when the drive unit 100 is connected to the electric motor 200. This means that cooling air can pass in the radial direction through the space formed between the first end surface 111 of the first casing 110 and the first end surface 211 of the second casing 210. The predetermined axial distance X1 can be achieved with distance means 212 being provided between the first end surface 111 of the first casing 110 and the first end surface 211 of the second casing 210. The distance means 212 may be formed by first protrusions 212 extending outwards in the axial direction X-X from the first end surface 211 of the second casing 210. The first protrusions 212 may be positioned at an angular distance from each other along the perimeter of the first end surface 211 of the second casing 210. The first protrusions 212 may be distributed in any pattern along the perimeter of the first end surface 211 of the second casing 210. The number of first protrusions 212 can be any suitable number needed in order to make sufficient support points between the first casing 110 and the second casing 210. Cooling air can thus pass between the first protrusions 212 into the space between the first end surface 111 of the first casing 110 and the first end surface 211 of the second casing 210. The first protrusions 212 could naturally instead extend outwards from the first end surface 111 of the first casing 110 towards the first end surface 211 of the second casing 210.

The cooling may be intensified by providing a fan 245 on the shaft of the rotor of the electric motor 200. The fan 245 may be positioned in the space between the first end surface 111 of the first casing 110 and the first end surface 211 of the second casing 210 or in a space within the second casing 210 near the first end surface 211 of the second casing 210 or near the drive pulley 250. Another possibility would be to use an external fan blowing air towards the drive unit 100 and the electric motor 200. A cooling air channel arrangement could be used in order to direct the cooling air from the external fan to the drive unit 100 and the electric motor 200.

The first end surface 111 and/or some other outer surface of the first casing 110 and/or the first end surface 211 and/or some other outer surface of the second casing 210 may be provided with cooling fins in order to intensify the cooling of the drive unit 100 and/or the electric motor 200.

The first end surface 111 of the first casing 110 may comprise first fastening means 120, 121, 122 in the form of cylindrical second protrusions 120, 121, 122 extending axially X-X outwards from the first end surface 111 of the first casing 110. Each of the second protrusions 120, 121, 122 may be provided with a circular groove 120A, 121A, 122A extending inwards from the outer circumference of the second protrusion 120, 121, 122 and being positioned at a distance from an outer end of the second protrusions 120, 121, 122. The second protrusions 120, 121, 122 may be positioned at an angular distance from each other along the perimeter of the first end surface 111 of the first casing 110. The second protrusions 120, 121, 122 may be distributed in any pattern along the perimeter of the first end surface 111 of the first casing 110. The number of second protrusions 120, 121, 122 can be any suitable number needed in order to make a firm connection between the first casing 110 and the second casing 210. The figure shows three second protrusions 120, 121, 122, which seems to be an advantageous number.

The first end surface 211 of the second casing 210 comprises second fastening means 220, 221, 222 engaging with the first fastening means 120, 121, 122 i.e. the second protrusions 120, 121, 122. The second fastening means 220, 221, 222 may be formed by elongated openings 220, 221, 222 having a wider portion at one end of the opening 220, 221, 222.

The first casing 110 comprising the drive unit 100 can first be pushed in the axial direction X-X towards the second casing 210 comprising the electric motor 200 so that the outer ends of the second protrusions 120, 121, 122 pass through the wider portion of the openings 220, 221, 222 in the first end surface 211 of the second casing 210. The outer ends of the first protrusions 212 will seat against the first end surface 111 of the first casing 110. The drive unit 100 can thereafter be pushed in a transverse direction Y-Y in relation to the axial direction X-X so that the edges of the narrower portion of the openings 220, 221, 222 in the first end surface 211 of the second casing 210 grip into the circular grooves 120A, 121A, 122A in the second protrusions 120, 121, 122, whereby the drive unit 100 becomes locked to the electric motor 200.

The first fastening means 120, 121, 122 i.e. the second protrusions 120, 121, 122 and the second fastening means 220, 221, 222 can naturally be reversed so that the first end surface 211 of the second casing 210 comprises the second protrusions 120, 121, 122 and the first end surface 111 of the first casing 110 comprises the second fastening means 220, 221, 222 i.e. the elongated openings.

The rectangular first casing 110 has a thickness T1 in the axial direction X-X, a width W1 in a horizontal direction Y-Y being perpendicular to the axial direction X-X, and a height H1 in a vertical direction Z-Z being perpendicular to the axial direction X-X. The width W1 and the height H1 of the first casing 110 are advantageously 2-10 times the thickness T1 of the first casing 110. A vertical cross section of the first casing 110 has advantageously the form of a rectangle. The rectangle may be a quadrature.

The cylindrical second casing 210 has a length T2 in the axial direction X-X and a diameter D1 in a direction perpendicular to the axial direction X-X. The diameter D1 of the second casing 210 may be smaller than the width W1 or height H1 of the first casing 110.

The first end surface 111 of the first casing 110 may further comprise electrical socket connections 130, 131 and the first end surface 211 of the second casing 210 comprises corresponding electrical plug connections 230, 231. The electrical plug connections 230, 231 and the electrical socket connections 130, 131 will be connected automatically when the drive unit 100 is pushed in the transverse direction Y-Y in order to connect the drive unit 100 to the electric motor 200.

The electrical socket connections 130, 131 and the electrical plug connections 230, 231 can naturally be reversed so that the first end surface 211 of the second casing 210 comprises the electrical socket connections 130, 131 and the first end surface 111 of the first casing 110 comprises the electrical plug connections 230, 231.

The drive unit 100 can be supplied with electric power from a one phase or three phase AC electric grid via a power cord that is connected with a plug 610 to the drive unit 100. The main control unit 500 and the drive unit 100 can further be connected with a data transmission cable that is connected with a plug 620 to the drive unit 100. The transfer of electric power from the drive unit 100 to the electric motor 200 is done through one of the electrical socket 130 and electrical plug 230 connections between the drive unit 100 and the electric motor 200. The transfer of data between the drive unit 100 and the motor 200 is done through the other of the electrical socket 131 and electrical plug 231 connections between the drive unit 100 and the electric motor 200.

The drive unit 100 may further comprise a sensor 140 for measuring the rotation speed and the angular position of the rotor of the electric motor 200. This sensor 140 may be integrated into the first casing 110. The sensor may comprise a complete sensor unit having a shaft that will be connected to the shaft 240 of the rotor of the electric motor 200 when the first casing 110 is connected to the second casing 210. The shaft of the sensor 140 will thus rotate in synchronism with the shaft of the rotor of the electric motor 200. The sensor 140 may be an encoder.

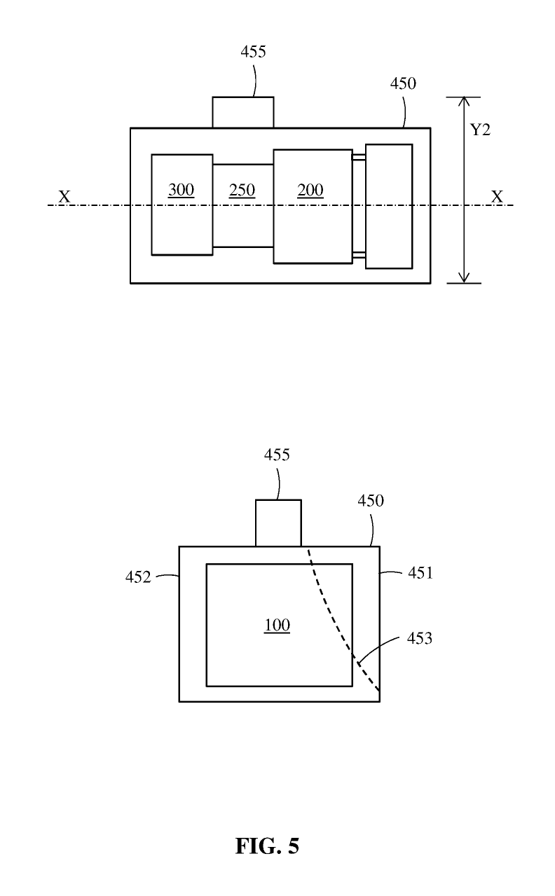

FIG. 5 shows a vertical and a horizontal cross section of a lifting machinery enclosed in a watertight box. The lifting machinery 400 i.e. the drive unit 100, the electric motor 200, the drive pulley 250 and the machinery brake 300 may be positioned in a watertight box 450 when protection against flooding is needed. The watertight box 450 will prevent water from penetrating into the lifting machinery 400. The box 450 is provided with an upwards directed collar 455 forming an opening for the traction belt 43 passing from the bottom of the car 10 down to the drive pulley 250 and back up from the drive pulley 250 to the lower deflection pulley 51. The passing of the traction belt 43 down to the box 450 and up from the box 450 within the collar 455 may be sealed so that water cannot at least easily penetrate into the box 450 from the collar 455. The box 450 is thus fully watertight at least up to the height Y2 of the upper end of the collar 455. The box 450 is advantageously made of two halves 451, 452. The first half 451 can be disconnected from the second half 452 in order to provide access to the lifting machinery 400 inside the box 450. The first half 451 has a first edge surface seating against a corresponding second edge surface in the second half 452. A sealing may be provided between the first edge surface and the second edge surface. The first half 451 may be attached with snap locking means to the second half 452. The figure shows the connection line 453 between the edge surfaces of the two halves 451, 452. The removal of the first half 451 will provide access for a mechanic in order to perform maintenance work to the lifting machinery 400. The lifting machinery 400 may be supported e.g. from support points in the frame of the drive pulley 250 to a frame construction, which is not shown in the figure. The support of the lifting machinery 400 on the frame construction may be arranged by pivot arms so that the lifting machinery 400 may be turned around the pivot points in order to loosen and tighten the belt 43.

The cooling of the drive unit 100 and the electric motor 200 may in case they are enclosed in the box 450 be arranged e.g. by an external fan. The box 450 will form a cooling air channel through which cooling air can be conducted to the drive unit 100 and the electric motor 200. The cooling air will also pass through the radial passage between the first end 111 of the first casing 110 and the first end 211 of the second casing 210. The fan could naturally also be positioned on the rotor shaft of the electric motor 200.

The lifting machinery 400 shown in the figures is based on air cooling i.e. the drive unit 100 and the electric motor 200 is cooled by air. The air cooling may be intensified with an arrangement using a cooling liquid in order to transfer heat from the drive unit 100 and/or the electric motor 200 to the cooling liquid. The installation costs and the operation costs of an arrangement using a cooling liquid are normally higher compared to a simple air cooling system.

The drive unit 100 is advantageously a frequency converter being connected to a one phase or three phase AC electric power grid. The frequency converter 100 supplies one phase or three phase frequency controlled AC electric power to the electric motor 200.

The electric motor 200 is advantageously a one phase or three phase permanent magnet synchronous motor. The electric motor 200 may be a radial magnetic flow type electric motor 200 or an axial magnetic flow type electric motor 200. A radial magnetic flow electric motor 200 may be formed of a concentric rotor and stator, whereby a radially extending air gap is formed between the rotor and the stator of the electric motor 200. An axial magnetic flow electric motor 200 may be formed of a disc type rotor and a disc type stator being separated by an axial X-X distance, whereby an axially extending air gap is formed between the rotor and the stator of the electric motor 200. The frequency converter 100 controls the rotation of the electric motor 200. The rotation speed and the angular position of the shaft of the rotor of the electric motor 200 may be measured with a sensor 140 integrated into the first casing 110. The sensor 140 may be provided with a shaft protruding out from the first casing 100 and being connected to the shaft of the rotor of the electric motor 200 protruding out from the second casing 210. The measured rotation speed and angular position may be supplied as an input signal to the frequency converter 100. The frequency converter 100 may also receive a rotational speed reference i.e. a target value of the rotational speed of the electric motor 200 from a main control unit 500.

The predetermined axial distance X1 between the first surface 111 of the first casing 110 and the first surface 211 of the second casing 210 is advantageously in the range of 10 to 50 mm.

The invention is not restricted to be used only in the elevator enclosed in the figures. The invention can be used e.g. in a top driven elevator, in a bottom driven elevator, in an elevator with a machine room, in an elevator without a machine room, in an elevator with a counter weight, in an elevator without a counter weight, and in an elevator where the lifting machinery is positioned on a wall in the shaft between the top and the bottom of the shaft.

The invention can be used in any kind of elevator having any kind of transmission means with any kind of roping ratio based on any combination of ropes and belts or based on ropes only or based on belts only as long as the car is driven in response to a drive pulley mounted on the shaft of the rotor of the electric motor. A drive pulley means in this application a pulley driven by an electric motor, whereby at least a part of the rope system or belt system runs over the drive pulley. The invention can be used in connection with a traction drive system and in connection with a positive drive system.

A traction drive system is based on a drive pulley and a rope or belt passing over the drive pulley. The rope may have a circular cross section, whereby the drive pulley is provided with a corresponding groove receiving the rope. The belt may have a generally rectangular cross section, the width of the belt being greater than the height of the belt, whereby the drive pulley is provided with a crowning receiving the flat belt. The rope and the belt are both kept in place on the drive pulley by the friction between the rope or belt and the pulley. There can be one or several parallel connected ropes or belts running over the drive pulley. The inner surface of the belt could instead of being flat have a poly-V shape. The inner surface would thus comprise several longitudinal grooves separated by longitudinal neck portions. The outer surface of the drive pulley would then have a corresponding shape.

A positive drive is based on a cogged belt passing over a cogged drive pulley. The belt is kept in place on the drive pulley by the cogs of the belt seating on the corresponding cogs on the outer surface of the drive pulley. The FIGS. 1 and 2 show a positive drive system. The car 10 is driven by the drive pulley 250 positioned at the bottom of the shaft 20. The cogged belt 43 passes over the drive pulley 250, whereby the car 10 is moved upwards and downwards in response to the rotation of the drive pulley 250.

The fastening of the first casing 110 to the second casing 210 is also not restricted to the snap lock mechanism shown in the figures. This fastening can be done by any fastening means achieving a snap locking or an otherwise detachable locking between the first casing 110 and the second casing 210. The first fastening means 120, 121, 122 i.e. the second protrusions 120, 121, 122 could e.g. be substituted by screws connecting the first casing 110 to the second casing 210. The second fastening means 220, 221, 222 could in such case be substituted by holes with an internal threading for the screws. There could e.g. be lugs in the first casing 110 and/or in the second casing 210 for the screws. The electrical connections 130, 131, 230, 231 could in such case be directed so that they could be connected to each other in the axial X-X direction. The axial distance X1 between the opposed first end surfaces 111, 211 of the first casing 110 and the second casing 210 could in such case be achieved e.g. with bushings positioned between opposite lugs i.e. the bushings would form the distance means 212. The screws would pass through the bushings i.e. through the distance means.

The lifting machinery 400 comprises in the figures a drive unit 100, an electric motor 200, a drive pulley 250 and a machinery brake 300. This is an advantageous embodiment, but the invention is not restricted to this embodiment. The position and the order of the components in the lifting machinery 400 could vary. The machinery brake 300 may e.g. be integrated into the electric motor 200. The lifting machinery 400 must, however, comprise a drive unit 100, an electric motor 200 and a drive pulley 250 and the first end 111 of the drive unit 100 must be positioned at the axial distance X1 from the first end 211 of the electric motor 200.

The drive unit 100 comprises in the figures a first casing 110, whereby the components of the drive unit 100 are positioned within the first casing 110. This is an advantageous embodiment, but the invention is not restricted to this embodiment. The drive unit 100 may e.g. comprise a sheet, whereby the surface of the sheet that faces towards the first surface 211 of the electric motor 200 forms the first surface 111 of the drive unit 100. The components of the drive unit 100 may be positioned on the opposite surface of the sheet. All other possible first casing 110 constructions forming a closed or partially open space within the first casing 110 could be used in the invention. The first surface 111 of the drive unit 100 and the first surface 211 of the electric motor 200 are in the figures planar. This is an advantageous embodiment, but the invention is not restricted to this embodiment. The first surface 111 of the drive unit 100 and/or the first surface 211 of the electric motor 200 could instead be curved or it could be formed of folded surfaces. The axial distance X1 between the first surfaces 111, 211 refers to the minimum axial distance X1 between the first surfaces 111, 211. The drive unit 100 may in all embodiments be supported only by the electric motor 200 i.e. the fastening means between the drive unit 100 and the electric motor 200 support the drive unit 100 on the electric motor 200.

The first end surface 111 of the drive unit 100 and the first end surface 211 of the electric motor 200 are thermally isolated. Small thermal bridges between the first end surface 111 of the drive unit 100 and the first end surface 211 of the electric motor 200 may be formed through the first protrusions 212 and/or through the second protrusions 120, 121, 122, but the first end surfaces 111, 211 are otherwise thermally isolated from each other. The impact of these small thermal bridges is negligible due to the small cross section area of the first protrusions 212 and/or the second protrusions 120, 121, 122 in relation to the area of the first end surface 111 of the drive unit 100 and the area of the first end surface 211 of the electric motor 200. These small thermal bridges could naturally be eliminated e.g. by providing a thermal barrier at either end of the protrusions or by using a thermally non-conductive material in the protrusions if needed.

It will be obvious to a person skilled in the art that, as the technology advances, the inventive concept can be implemented in various ways. The invention and its embodiments are not limited to the examples described above but may vary within the scope of the claims.

1. An elevator comprising a car moving upwards and downwards in an elevator shaft by a lifting machinery comprising a drive unit, an electric motor having an axis of rotation forming an axial direction (X-X), and a drive pulley, the drive unit being connected to an electrical power source and providing a controllable source of power to the electric motor, transmission means passing over the drive pulley and being connected to the car, wherein the drive unit comprises a first end surface and that the electric motor comprises a first end surface, the drive unit being attached to the electric motor so that a predetermined axial distance (X1) remains between the first end surface of the drive unit and the first end surface of the electric motor, said first end surfaces being opposite to each other.

2. The elevator according to claim 1, wherein the drive unit, the electric motor, and the drive pulley are positioned one after the other along the axial direction (X-X).

3. The elevator according to claim 1, wherein the first end surface of the drive unit and the first end surface of the electric motor are thermally separated.

4. The elevator according to claim 1, wherein the drive unit and the electric motor are cooled with air passing between the two first end surfaces.

5. The elevator according to claim 1, wherein a fan is attached to a shaft of a rotor of the electric motor.

6. The elevator according to claim 1, wherein the drive unit is supported by the electric motor when the drive unit is attached to the electric motor.

7. The elevator according to claim 1, wherein the drive unit comprises a first casing, the first surface of the drive unit being formed by a first surface of the first casing.

8. The elevator according to claim 7, wherein a sensor measuring the rotation speed or angular position of the rotor of the electric motor is integrated into the first casing.

9. The elevator according to claim 1, wherein distance means are provided between the first end surface of the drive unit and the first end surface of the electric motor, whereby the predetermined axial distance (X1) between the first end surface of the drive unit and the first end surface of the electric motor is determined by the distance means.

10. The elevator according to claim 9, wherein the first end surface of the drive unit or the first end surface of the electric motor first protrusions extending axially (X-X) outwards towards the opposite first end surface and being distributed along a perimeter of the first end surface.

11. The elevator according to claim 1, wherein the first end surface of the drive unit or the first end surface of the electric motor comprises first fastening means extending axially (X-X) outwards towards the opposite first end surface and being distributed along a perimeter of the first end surface.

12. The elevator according to claim 11, wherein the first end surface of the drive unit or the electric motor that is opposite to the first end surface comprising the first fastening means comprises second fastening means engaging with the first fastening means in order to attach the drive unit to the electric motor.

13. The elevator according to claim 11, wherein the first fastening means are formed of second protrusions.

14. The elevator according to claim 13, wherein the second protrusions are cylindrical and provided with a circular groove inwards from the outer circumference of the protrusion and being positioned at a distance from an outer end of the cylindrical protrusions.

15. The elevator according to claim 14, wherein the second fastening means are formed of elongated openings having a wider portion at one end of the opening so that the outer ends of the second protrusions can first be pushed in the axial direction (X-X) through the wider portion of the openings and thereafter in a transverse direction (Y-Y) in relation to the axial direction (X-X) so that the edges of the narrower portion of the openings grip into the circular grooves, whereby the drive unit becomes locked to the electric motor.

16. The elevator according to claim 1, wherein the first end surface of the drive unit or the first end surface of the electric motor comprises electrical socket connections and the opposite first end surface comprises corresponding electrical plug connections, whereby the electrical plug connections will be pushed automatically into the electrical socket connections when the drive unit is attached to the electric motor.

17. The elevator according to claim 1, wherein the elevator is a bottom driven elevator, whereby the lifting machinery comprising the drive unit, the electric motor, and the drive pulley is positioned on a bottom of the shaft.

18. The elevator according to claim 17, wherein the transmission means comprises an upper suspension rope passing from a top of the car upwards to a top of the shaft, over upper deflection pulleys at the top of the shaft, and further downwards to a top of the counter weight, and a lower traction belt passing from a bottom of the car downwards to a bottom of the shaft, over the drive pulley, over lower deflection pulleys, all positioned at the bottom of the shaft, and further upwards to a bottom of the counter weight.

19. The elevator according to claim 17, wherein the lifting machinery comprising the drive unit, the electric motor, and the drive pulley is enclosed within a watertight box.
